(19) United States
(12) Patent Application Publication
(10) Pub. No.: US 2020/0071925 A1
(43) Pub. Date: Mar. 5, 2020

(54) Collapsible Container

(71) Applicant: Mobihom Co Limited, Hong Kong (HK)

(72) Inventor: Wing Haye Michael Shum, Hong Kong (HK)

(21) Appl. No.: 16/503,633

(22) Filed: Jul. 5, 2019

Related U.S. Application Data
(63) Continuation-in-part of application No. 16/120,447, filed on Sep. 3, 2018, now abandoned.

(51) Int. Cl. E04B 1/348; E04B 1/74; E04B 1/68; E04B 1/343

(52) U.S. Cl. CPC E04B 1/348; E04B 1/74; H02S 20/30; E04B 1/34357; E04B 2001/34892; E04B 1/68

(57) ABSTRACT

A collapsible container designed for usage as a living space is disclosed. The collapsible container may comprise a top wall, a base, two end walls, and two side walls. When collapsed, the two end walls may fold inwards towards the base. At least one end wall of the two end walls may comprise a first opening to be used as a door or a window. The two side walls may be adapted to fold in middle, along lengths of the two side walls. The two side walls may be folded using at least one top hinge, middle hinge, and a bottom hinge present on each side wall of the two side walls. Further, the at least one side wall of the two side walls may comprise a second opening. Each of the two side walls comprises a safety device adapted to refrain the side walls from collapsing when erected.

### REFERENCE TO RELATED APPLICATION

This U.S. patent application is a Continuation-In-Part of U.S. patent application Ser. No. 16/120,447 which was filed on Sep. 3, 2018, the contents of which are hereby incorporated by reference in its entirety.

### FIELD OF THE INVENTION

The present disclosure is generally related to collapsible containers, and more particularly related to collapsible containers designed for utilization as living spaces.

### BACKGROUND OF THE INVENTION

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Containers are generally used for transportation of goods through ships and land based vehicles. Collapsible containers are also known for a long time. Such containers allow folding while being devoid of goods to be carried, thereby providing a compact size when storage space is less. Due to presence of foldable ends/walls in such containers, they lack a hermetically sealed mechanism. Lack of such hermetically sealed mechanism makes these containers inappropriate for usage as living spaces. Environmental factors such as wind, dust, rain, snow, and heat could easily enter inside and heavily affect the containers. Further, conventional containers also lack a suitable mechanism for creating living spaces of different sizes, customized based on an individual's requirement. Thus, a collapsible container that could block entry of the environmental factors and could be used to create living spaces of different areas is much desired.

### DISCLOSURE OF THE INVENTION

According to the present invention, there is provided a collapsible container comprising a top wall; a base; two end walls adapted to fold inwards towards the base, when collapsed, wherein at least one end wall of the two end walls comprise a first opening to be used as a door or a window; two side walls adapted to fold in the middle, along lengths of the two side walls, wherein at least one side wall of the two side walls comprises a second opening; and each of the two side walls comprises a safety device adapted to refrain the side walls from collapsing when erected.

Preferably, the safety device comprises at least one slot on each of the upper segment and lower segment of the side walls adapted to receive a strip.

Alternatively, the safety device may comprise a L-shape plate adapted to be secured to the upper segment and lower segment of the side walls. p It is preferred that each of the two side walls comprises a middle frame, exterior panels on the exterior side of the middle frame and interior panels on the interior side of the middle frame.

Preferably, the second opening is adapted to receive a panel for closing the second opening.

The panel may be fixed within the second opening using bolts.

Preferably, the panel is insulated.

It is preferred that the edges of the panel are pneumatically-sealed.

Preferably, the two end walls are fixed using bolts when the two end walls are erected.

Preferably, the two side walls fold in the middle using at least one top hinge, middle hinge, and bottom hinge present on each side wall of the two side walls.

It is preferred that each of the top wall, the base, the two side walls, and the two end walls are insulated.

Preferably, solar panels present on the top wall for generating power.

The collapsible container may further comprise ducts present in at least one of the top wall, the base, and the two side walls.

Preferably, the ducts are used for carrying electrical wirings, cold or warm water, or waste water.

The collapsible container may further comprise a second collapsible container joined alongside the collapsible container for creating a bigger living space, wherein the collapsible container and the second collapsible container are adjoined along a side wall of the two side walls of the collapsible container and a side wall of the second collapsible container.

The collapsible container may further comprise positioning a second collapsible container over the collapsible container.

### BRIEF DESCRIPTION OF THE DRAWINGS

The accompanying drawings illustrate various embodiments of systems, methods, and embodiments of various other aspects of the disclosure. Any person with ordinary skills in the art will appreciate that the illustrated element boundaries (e.g. boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1A illustrates a perspective view of a collapsible container present in a partially open condition, according to an embodiment.

FIG. 1B illustrates a perspective view of a collapsible container present in a semi-closed condition, according to an embodiment.

FIG. 1C illustrates a perspective view of a collapsible container present in a completely closed condition, according to an embodiment.

FIG. 2 illustrates a side view of the collapsible container comprising a plurality of hinges, according to an embodiment.

FIG. 3A illustrates a fully extended condition of a top hinge 200 and FIG. 3B illustrates a partially folded condition of the top hinge 200, according to an embodiment.

FIG. 4A illustrates a fully extended condition of a bottom hinge 202 and FIG. 4B illustrates a partially folded condition of the bottom hinge 202, according to an embodiment.

FIG. 5A illustrates a fully extended condition of a middle hinge 204 and FIG. 5B illustrates a partially folded condition of the middle hinge 204, according to an embodiment.

FIG. 6A illustrates a first perspective view of a collapsible container comprising a first opening, according to an embodiment.

FIG. 6B illustrates a second perspective view of the collapsible container comprising the first opening, according to an embodiment.

FIG. 7A illustrates a perspective view of a collapsible container showing a second opening adapted for receiving a panel, according to an embodiment.

FIG. 7B illustrates a perspective view of a collapsible container showing the panel fitted into the second opening, according to an embodiment.

FIG. 8A and FIG. 8B illustrate multi-container configurations utilizing two collapsible containers, according to an embodiment.

FIG. 9 illustrates a perspective view of an embodiment of the safety device comprising two slots and a strip.

FIG. 10 illustrates a perspective view of another embodiment of the safety device comprising a L-shape plate.

FIG. 11 illustrates a side view of the side wall comprising a middle frame, exterior panels and interior panels.

### DETAILED DESCRIPTION

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present disclosure, the preferred, systems and methods are now described.

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

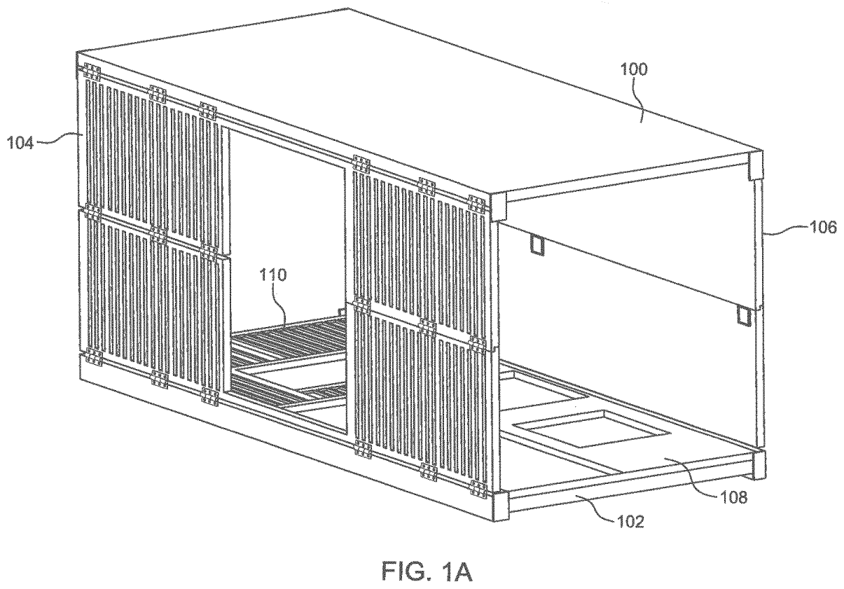

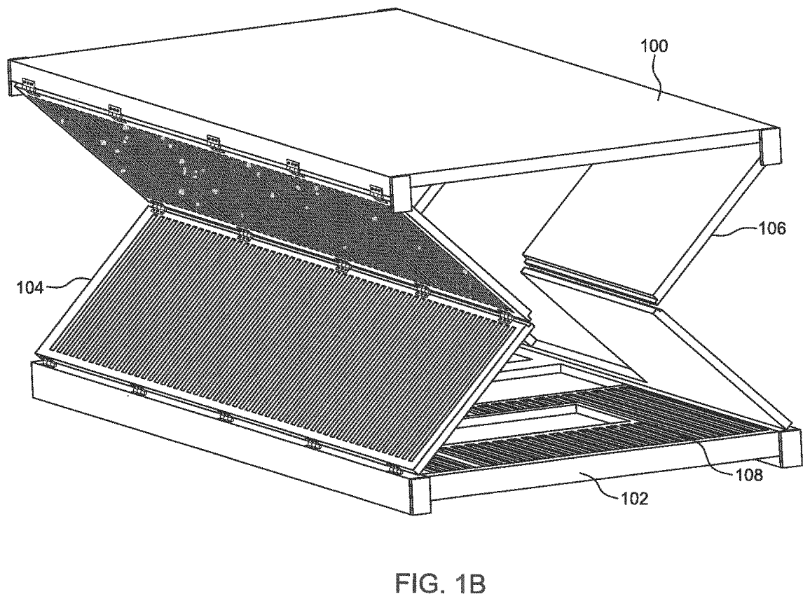

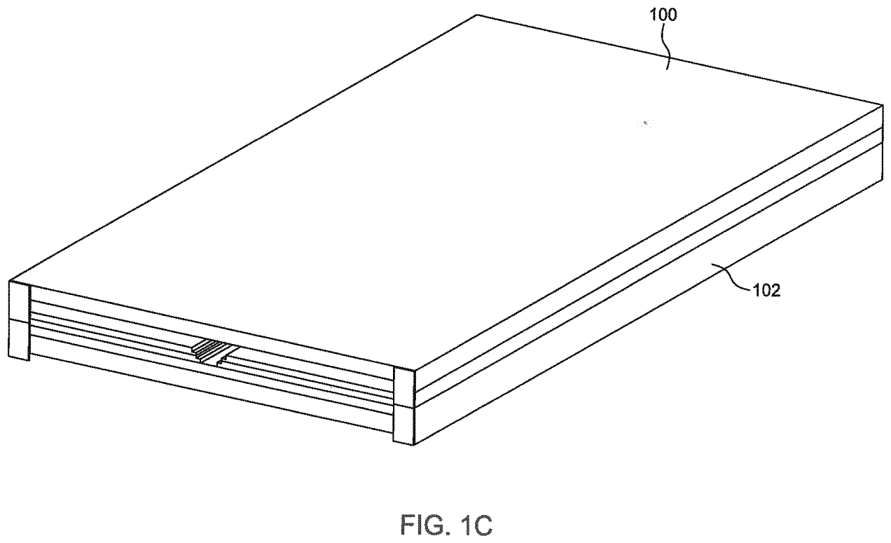

In one embodiment, referring to FIG. 1A, structural aspects of a collapsible container present in a partially open condition are explained. FIG. 1A illustrates a perspective view of the collapsible container present in a partially open condition. The collapsible container may comprise a top wall 100, a base 102, a first side wall 104, a second side wall 106, a first end wall 108, and a second end wall 110. The first side wall 104 and the second side wall 106 may be adapted to fold in middle, when expanded along lengths. Further, the first end wall 108 and the second end wall 110 may be adapted to fold inwards towards the base 102. It should be noted that material used for constructing the collapsible container should not be restricted to materials such as metals like iron or aluminum, fiberboard, cardboard, and plastic, like PVC, as well as cardboard having a water resistant paper, polymeric film, or metallicized film layer, or coating to construct a moisture resistant storage container.

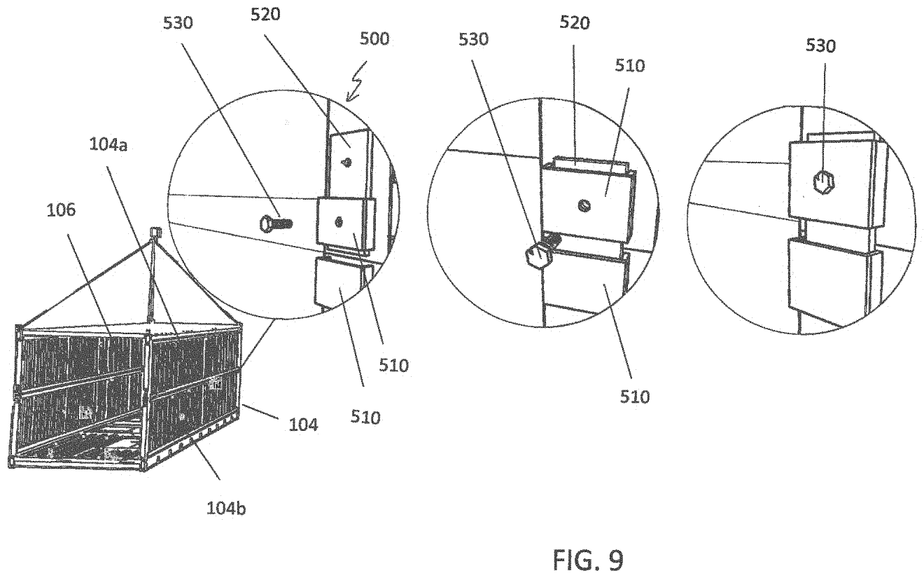

It is shown in FIG. 9 that the second side wall 104 may comprise a safety device 500 adapted to refrain the first side wall 104 from collapsing when erected. The safety device 500 comprises at least one slot 510 on each of the upper segment 104a and lower segment 104b of the first side wall 104 adapted to receive a strip 520. The strip 520 may be secured to the slot 510 by fastening means 530 which in turn refrains the first side wall 104 from collapsing when erected. In this embodiment, the fastening means 530 is a screw but shall be any suitable fastening means and not be restricted to a screw. The second side wall 106 may comprise the same safety device 500 as the second side wall 104 (not shown).

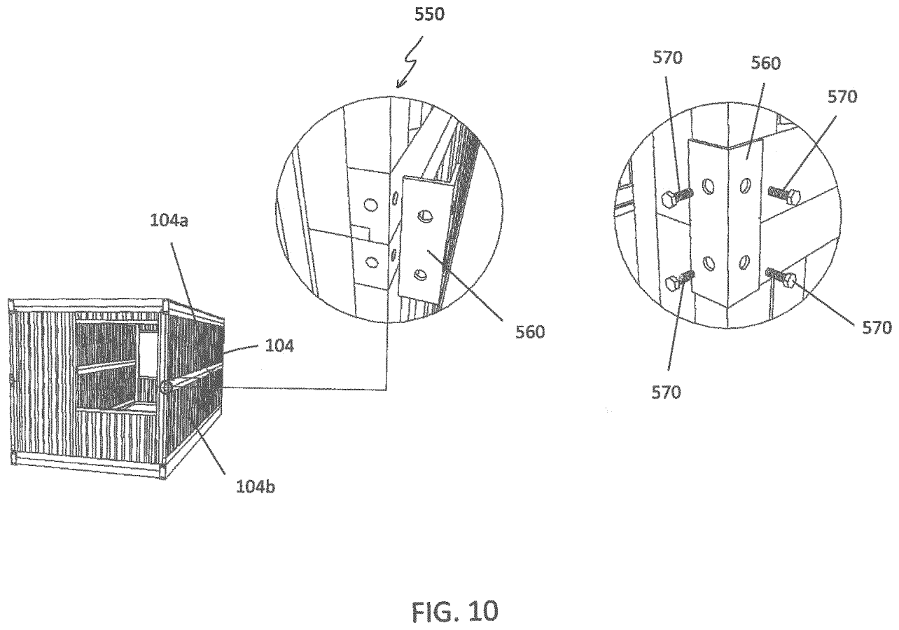

In another embodiment, referring to FIG. 10, a safety device 550 comprises a L-shape plate 560 adapted to be secured to the upper segment 104a and lower segment 104b of the first side wall 104 in order to refrain the first side wall 104 from collapsing when erected. The L-shape plate 560 may be secured to the upper segment 104a and lower segment 104b of the first side wall 104 by fastening means 570 which in turn refrains the first side wall 104 from collapsing when erected. The second side wall 106 may comprise the same safety device 550 as the second side wall 104 (not shown).

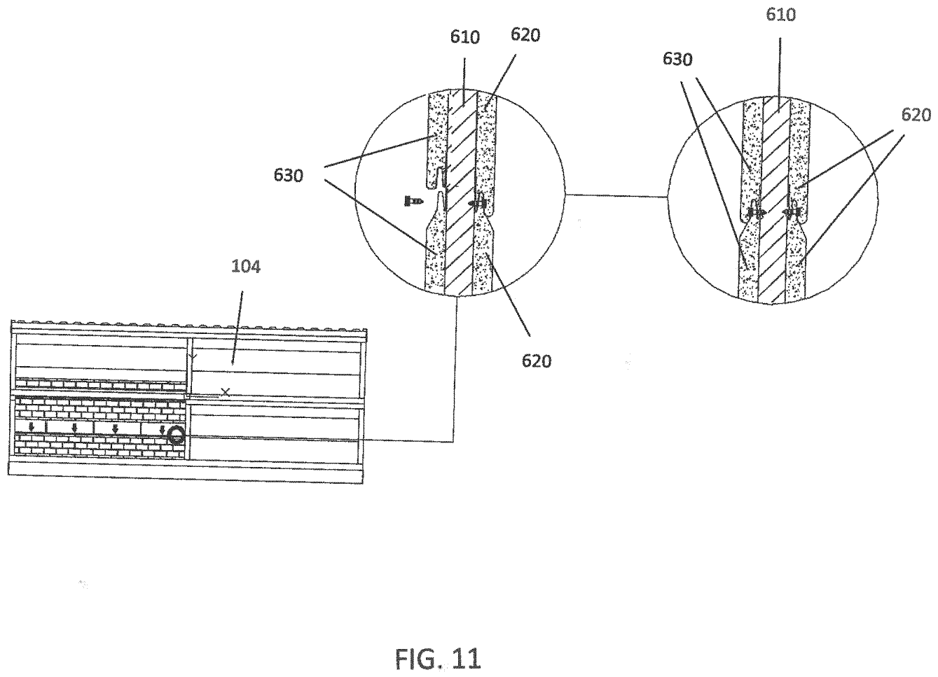

FIG. 11 shows that the first side wall 104 comprises a middle frame 610, exterior panels 620 on the exterior side of the middle frame 610 and interior panels 630 on the interior side of the middle frame 610. The exterior panels 620 are inter-locked each other and secured to the middle frame 610 by fastening means. Similarly, the interior panels 630 are inter-locked each other and secured to the middle frame 610 by fastening means. The exterior panels 620 may be insulated, and edges of the exterior panels 620 may be pneumatically-sealed. Such a pneumatically sealed arrangement may prevent entry of environmental agents such as sand, pollen, rain, snow, and hot/cold air. Barring ingress of such environmental agents would thus allow maintaining favorable living conditions, such as a suitable temperature, within the collapsible container, when used as a living space. The interior panels 630 may have aesthetic finishing giving a pleasant appearance as a living space.

In one embodiment, referring to FIG. 1B, structural aspects of the collapsible container present in a semi-closed condition are explained. FIG. 1B illustrates a perspective view of the collapsible container present in a semi-closed condition. While collapsing the container, the first side wall 104 and the second side wall 106 may fold inwards, from middle, along lengths of the first side wall 104 and the second side wall 106. In one case, the semi-collapsed state may take up a volume approximately one quarter of that of a fully erected collapsible container.

In one embodiment, referring to FIG. 1C, structural aspects of the collapsible container present in a completely closed condition are explained. FIG. 1C illustrates a perspective view of a collapsible container present in a completely closed condition. The first side wall 104 and the second side wall 106 could get sandwiched between the top wall 100 and the base 102. In one case, a completely closed container may be opened by lifting the top wall 100 using a fork lift. For example, the top wall 100 may comprise a rectangular reinforced structure including forklift tyne pockets (not illustrated in diagram) and a fixing block at each corner (not illustrated in diagram) for allowing lifting of the top wall 100. Further, the first side wall 104 and the second side wall 106 may be fixed using bolts when the two end walls are erected.

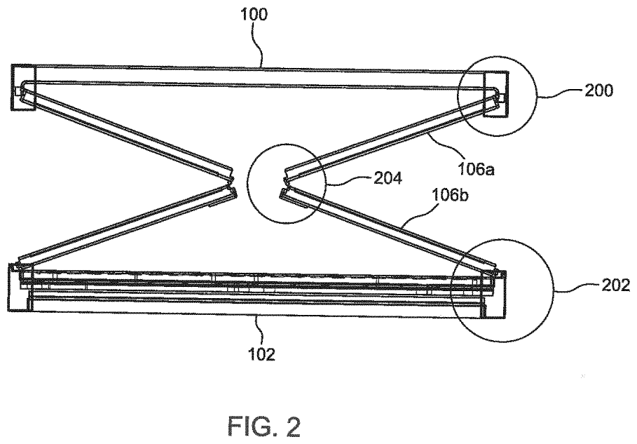

In one embodiment, referring to FIG. 2, a hinge mechanism used in the collapsible container is explained. FIG. 2 illustrates a side view of the collapsible container comprising a plurality of hinges. In one case, a top hinge 200 may be present between the top wall 100 and the second side wall 106. Further, a bottom hinge 202 may be present between the base 102 and the second side wall 106. Further, a middle hinge 204 may be present between two segments of the second side wall 106 i.e. a first segment 106a of the second side wall 106 and a second segment 106b of the second side wall 106. Similarly, other hinges may be present on other edges and corners of the container, for allowing folding of the container.

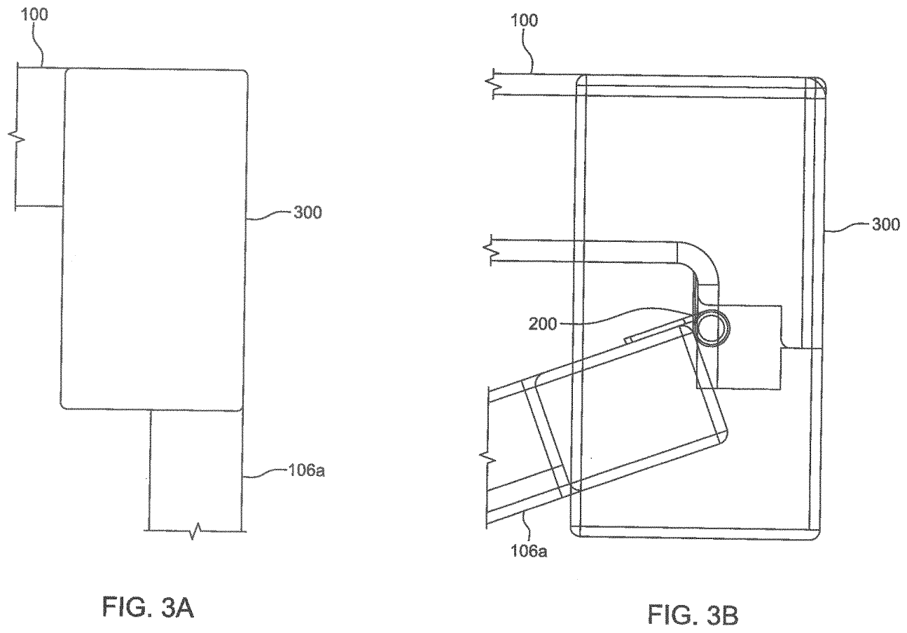

Referring to FIG. 3A and FIG. 3B, mechanisms for obtaining a fully extended condition and a partially folded condition of the top hinge 200 are explained respectively. The top hinge 200 may allow for movement between the top wall 100 and the first segment 106a of the second side wall 106. When present in a fully extended condition, as illustrated in FIG. 3A, the top wall 100 and the first segment 106a of the second side wall 106 may be present at a right angle i.e. 90°. Further, when present in a partially folded condition, as illustrated in FIG. 3B, the top wall 100 and the first segment 106a of the second side wall 106 may be present at an angle lesser than a right angle. In a completely folded condition, the top wall 100 and the first segment 106a of the second side wall 106 may overlap each other. An enclosure 300 may be present around each corner present on top of the collapsible container, for example as shown at corner of the top wall 100 and the first segment 106a of the second side wall 106. The enclosure 300 may prevent sand and wind to enter from corners of the collapsible container.

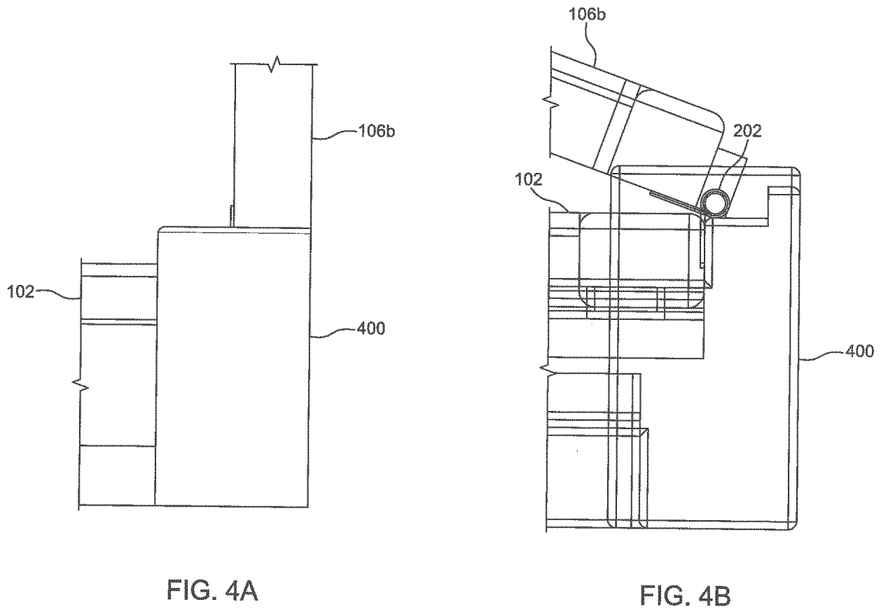

Referring to FIG. 4A and FIG. 4B, mechanisms for obtaining a fully extended condition and a partially folded condition of the bottom hinge 202 are explained. The bottom hinge 202 may allow for movement between the base 102 and the second segment 106b of the second side wall 106. When present in a fully extended condition, as illustrated in FIG. 4A, the base 102 and the second segment 106b of the second side wall 106 may be present at a right angle i.e. 90°. Further, when present in a present in a partially folded condition, as illustrated in FIG. 4B, the base 102 and the second segment 106b of the second side wall 106 may be present at an angle lesser than the right angle. In a completely folded condition, the base 102 and the second segment 106b of the second side wall 106 may overlap each other. An enclosure 400 may be present around each corner present on bottom of the collapsible container, for example as shown around a corner of the base 102 and the second segment 106b of the second side wall 106. The enclosure 400 may prevent sand and wind to enter from corners of the collapsible container.

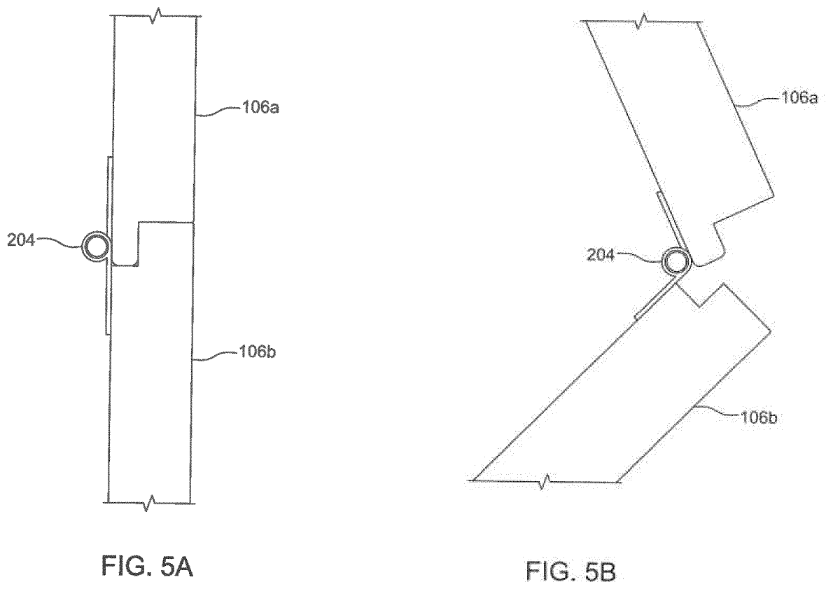

Referring to FIG. 5A and FIG. 5B, mechanisms for obtaining a fully extended condition and a partially folded condition of the middle hinge 204 are explained. The middle hinge 204 may allow for movement between the first segment 106a of the second side wall 106 and the second segment 106b of the second side wall 106. When present in a fully extended condition, as illustrated in FIG. 5A, the first segment 106a of the second side wall 106 and the second segment 106b of the second side wall 106 may be present next to each other i.e. at 180° angle. Further, when present in a partially folded condition, as illustrated in FIG. 5B, the first segment 106a of the second side wall 106 and the second segment 106b of the second side wall 106 may be present at an angle lesser than 180°. In a completely folded condition, the first segment 106a of the second side wall 106 and the second segment 106b of the second side wall 106 may overlap each other. The enclosure 300 may prevent sand and wind to enter from corners of the collapsible container. It should be noted that step shape of the first segment 106a of the second side wall 106 and the second segment 106b of the second side wall 106 may be designed to interlock each other tightly. Such tight interlocking may block entry of sand and wind to enter into the collapsible container.

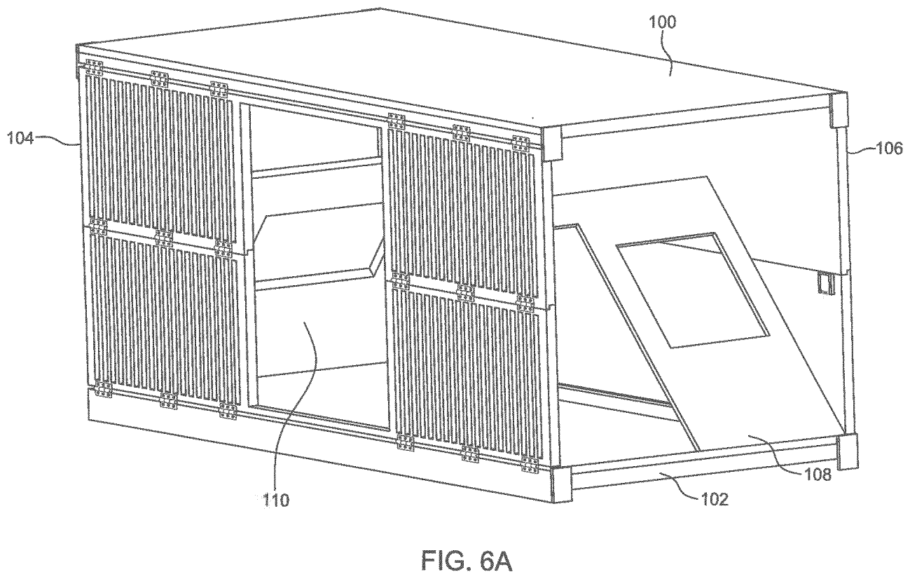

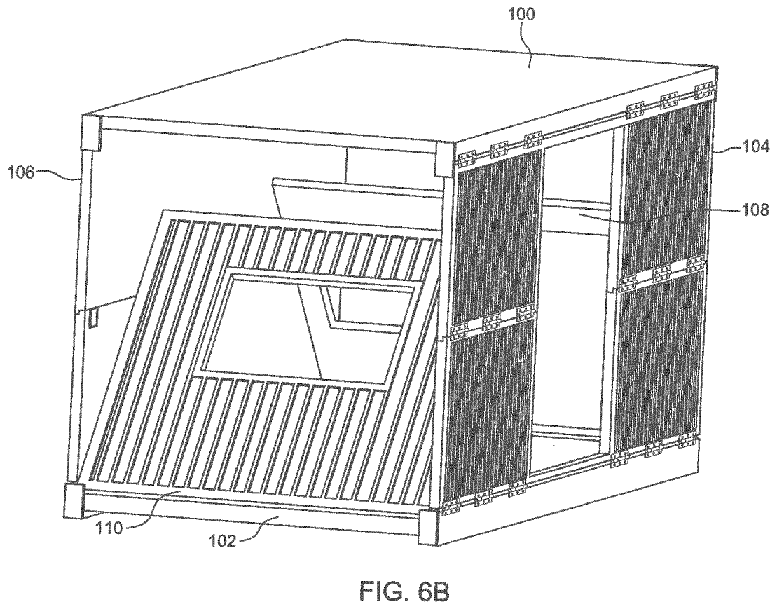

Referring to FIG. 6A and FIG. 6B, a first perspective view of the collapsible container comprising a first opening and a second perspective view of the collapsible container comprising the first opening, are explained. In one case, the first end wall 108 and the second end wall 110 may be adapted to fold inwards towards the base 102. Further, at least one of the first end wall 108 or the second end wall 110 may comprise a first opening. In one case, the first opening may be designed for use as a door or a window. As illustrated in FIG. 6A, the first opening present in the first end wall 108 is designed for use as a window and a door. Further, as illustrated in FIG. 6B, the first opening present in the second end wall 110 is designed for use as a window.

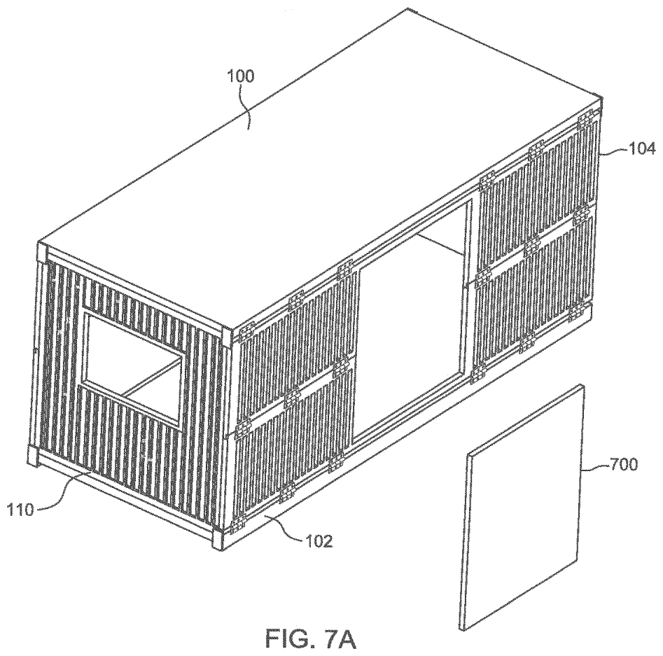

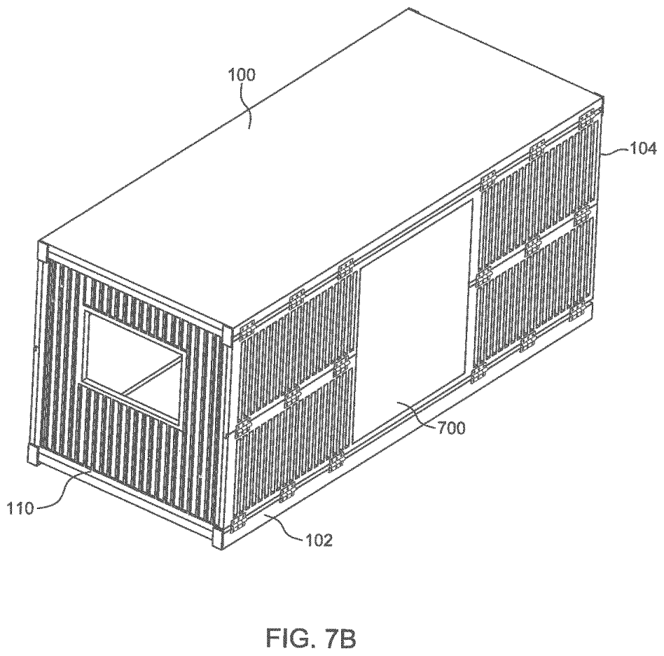

Referring to FIG. 7A and FIG. 7B, position and utilization of a second opening present in the collapsible container is explained. FIG. 7A illustrates a first perspective view of the collapsible container comprising the second opening adapted for receiving a panel 700. FIG. 7B illustrates a perspective view of the collapsible container showing the panel 700 fitted into the second opening. In one case, at least one of the first side wall 104 and the second side wall 106 may comprise the second opening. In one case, the second opening may be adapted to receive the panel 700 for closing the second opening. It should be noted that the panel 700 may be secured using bolts. In one case the panel 700 may be insulated, and edges of the panel 700 may be pneumatically-sealed when fitted in the second opening. Such a pneumatically sealed arrangement may prevent entry of environmental agents such as sand, pollen, rain, snow, and hot/cold air. Barring ingress of such environmental agents would thus allow maintaining favorable living conditions, such as a suitable temperature, within the collapsible container, when used as a living space.

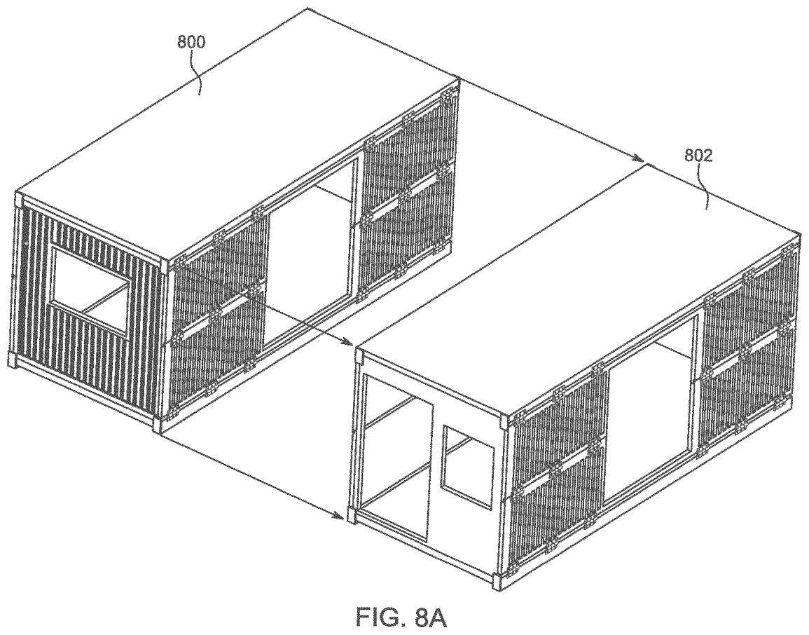

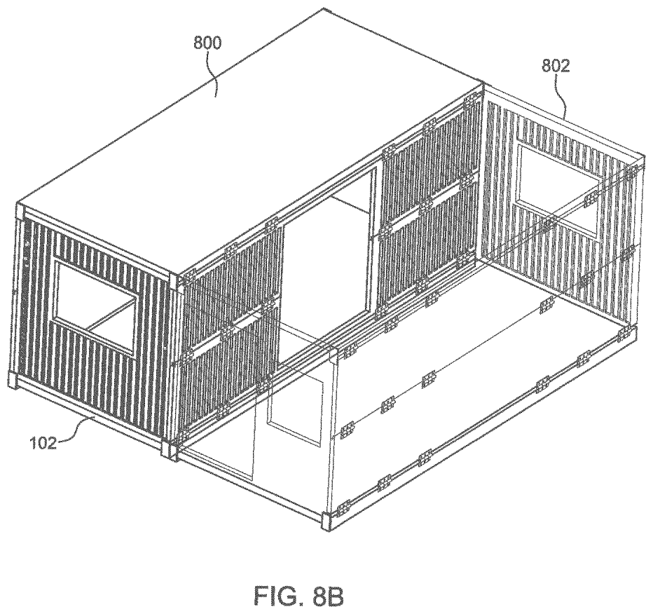

Referring to FIG. 8A and FIG. 8B, multi-container configurations utilizing two collapsible containers are explained. In one embodiment, as illustrated in FIG. 8A and FIG. 8B, a first collapsible container 800 and a second collapsible container 802 may be kept next to each other. The first collapsible container 800 and the second collapsible container 802 may be adjoined for creating a bigger living space. The first collapsible container 800 and the second collapsible container 802 may be adjoined along side walls comprising second openings. The second openings may provide for a passage between the first collapsible container 800 and the second collapsible container 802. Further, the first collapsible container 800 and the second collapsible container 802 may be adjoined using suitable connecting/locking means, such as bolts or screws. Similarly, multiple collapsible containers could be adjoined in different arrangements such as one behind another or one over another. Specifically, positioning the second collapsible container 802 over the first collapsible container 800 could help in creating a bigger living space over a limited area of ground.

In one embodiment, ducts may be provided in the top wall 100, the base 102, the first side wall 104, and/or the second side wall 106, of the collapsible container. The ducts may be used for carrying electrical wirings, cold or warm water, or waste water. It should be understood that separate ducts may be provided for serving separate functions. Further, solar panels may be attached to the top wall 102 for generating power. Such power i.e. current could be utilized for operation of electrical appliances present in the collapsible container.

The collapsible container can in any case undergo numerous modifications and variations, all of which are covered by the same innovative concept; moreover, all of the details can be replaced by technically equivalent elements. In practice, the materials used, as well as the shapes and sizes, can be whatever according to the technical requirements. The scope of protection of the invention is therefore defined by the attached claims.

What is claimed is:

1. A collapsible container comprising:
a top wall;
a base;
two end walls adapted to fold inwards towards the base, when collapsed, wherein at least one end wall of the two end walls comprise a first opening to be used as a door or a window;
two side walls adapted to fold in the middle, along lengths of the two side walls, wherein at least one side wall of the two side walls comprises a second opening; and
each of the two side walls comprises a safety device adapted to refrain the side walls from collapsing when erected.

2. The collapsible container of claim 1, wherein the safety device comprises at least one slot on each of the upper segment and lower segment of the side walls adapted to receive a strip.

3. The collapsible container of claim 1, wherein the safety device comprises a L-shape plate adapted to be secured to the upper segment and lower segment of the side walls.

4. The collapsible container of claim 1, wherein each of the two side walls comprises a middle frame, exterior panels on the exterior side of the middle frame and interior panels on the interior side of the middle frame.

5. The collapsible container of claim 1, wherein the second opening is adapted to receive a panel for closing the second opening.

6. The collapsible container of claim 5, wherein the panel is fixed within the second opening using bolts.

7. The collapsible container of claim 4, wherein the panel is insulated.

8. The collapsible container of claim 5, wherein the panel is insulated.

9. The collapsible container of claim 4, wherein edges of the panel are pneumatically-sealed.

10. The collapsible container of claim 5, wherein edges of the panel are pneumatically-sealed.

11. The collapsible container of claim 1, wherein the two end walls are fixed using bolts when the two end walls are erected.

12. The collapsible container of claim 1, wherein the two side walls fold in the middle using at least one top hinge, middle hinge, and bottom hinge present on each side wall of the two side walls.

13. The collapsible container of claim 1, wherein each of the top wall, the base, the two side walls, and the two end walls are insulated.

14. The collapsible container of claim 1, further comprising solar panels present on the top wall for generating power.

15. The collapsible container of claim 1, further comprising ducts present in at least one of the top wall, the base, and the two side walls.

16. The collapsible container of claim 15, wherein the ducts are used for carrying electrical wirings, cold or warm water, or waste water.

17. The collapsible container of claim 1, further comprising a second collapsible container joined alongside the collapsible container for creating a bigger living space, wherein the collapsible container and the second collapsible container are adjoined along a side wall of the two side walls of the collapsible container and a side wall of the second collapsible container.

18. The collapsible container of claim 1, further comprising positioning a second collapsible container over the collapsible container.
